(19) United States
(12) Patent Application Publication
(10) Pub. No.: US 2014/0091995 A1
(43) Pub. Date: Apr. 3, 2014

(54) DRIVING CIRCUIT, LCD DEVICE, AND DRIVING METHOD

(71) Applicant: Nianmao Wang, Shenzhen (CN)

(72) Inventor: Nianmao Wang, Shenzhen (CN)

(73) Assignee: SHENZHEN CHINA STAR OPTOELECTRONICS TECHNOLOGY CO., LTD., Shenzhen, Guangdong 518132 (CN)

(21) Appl. No.: 13/703,027

(22) PCT Filed: Nov. 5, 2012
(86) PCT No.: PCT/CN2012/084091

§ 371 Date: Dec. 9, 2012

(30) Foreign Application Priority Data
Sep. 29, 2012 (CN) 201210375124.9

(51) Int. Cl. G09G 3/36

(52) U.S. Cl. CPC G09G 3/3611
USPC 345/90

(57) ABSTRACT

A driving circuit for a multi-subpixel charge sharing type LCD panel includes a plurality of scan lines directly driven by gate driver chips. The driving circuit further includes a compensating line, and a level conversion module coupled to the compensating line. The level conversion module outputs a control signal to drive the compensating line after the level conversion module ends scanning of a last scan line and before the level conversion module begins scanning of next frame.

### TECHNICAL FIELD

The present disclosure relates to the field of liquid crystal displays (LCDs), and more particularly to a driving circuit, an LCD device, and a driving method.

### BACKGROUND

In developing a module for a large-size thin film transistor liquid crystal display (TFT-LCD) panel, in order to solve wide viewing angle color shifting problems, a low color shift (LCS) technique is usually used. As shown in FIG. 1, FIG. 1 is a schematic diagram of a driving structure of a typical multi-subpixel charge sharing type LCD panel. FIG. 2 is an interior circuit diagram of the LCD panel of FIG. 1, namely an LCS technique used in an interior circuit structure of the TFT-LCD panel. Principle of such structure is that one pixel is divided into a main area and a sub area. When a pulse of a first scan line G1 switches on a first row of the pixel, both the main area and the sub area are charged with a same voltage, and when pulse of a second scan line G2 switches on a second row of the pixel, a charge shearing switch CS on the first row is also switched on, which makes voltage and capacitance Cx1, Cx2 the sub area share a charge. At this moment, pixel voltages corresponding to the main area and the sub area are different, and display brightness corresponding to the main area and the sub area also is different. Because human eyes are affected by color mixing, pixel brightness becomes an intermediate brightness of the color mixing of the main area and the sub area. Thus, brightness of large view angle is approximately closer to brightness of the front view angle (as shown in FIG. 3). However, the LCS structure needs to be additionally added with a compensating line for the original scan lines.

As shown in FIG. 2, G1-G1080 are scan lines, and G1081 is a compensating line. In the prior art, both the scan lines and the data lines need to be driven by gate driver chips. Thus, the number of channels output by the gate driver chips should be one more than the number of display rows of the LCD. As shown in FIG. 2, the number of the channel output by the gate driver chips is 1081. At present, all the number of the channels output by typical gate driver chips can be divided by 1080 exactly, for example, 270 channels, 360 channels, 540 channels can achieve output of 1080 channels by using four, three, and two gate driver chips in parallel, respectively. However, driver of last row of the LCS structure cannot be supported shown in FIG. 2. A typical method is that the gate driver chips output the channels that are more than the 1081 channels that are used to drive 1081 row, where redundant channels are abandoned causing waste of the channels. Moreover, the channels outputted each the gate driver chip in parallel are different, and pins relative to the number of the channels output by the gate driver chips as high level or low level are arranged in a complicated manner.

### SUMMARY

In view of the above-described problems, the aim of the present disclosure is to provide a simple-design driving circuit, a liquid crystal display (LCD) device, and a driving method capable of controlling the compensating line without occupying channels of gate driver chips.

The aim of the present disclosure is achieved by the following technical scheme.

A driving circuit for a multi-subpixel charge sharing type liquid crystal display (LCD) panel comprises a plurality of scan lines directly driven by gate driver chips, a compensating line, and a level conversion module coupled to the compensating line. The level conversion module outputs a control signal to drive the compensating line after the level conversion module ends scanning of a last scan line and before the level conversion module begins scanning of a next frame.

Furthermore, the level conversion module comprises a first controllable switch that switches on at a high level, a second controllable switch is switched on at a low level, and as channel control unit that controls the first controllable switch and the second controllable switch. An input end of the first controllable switch is coupled to a reference high-level signal, and an input end of the second controllable switch is coupled to a reference low-level signal. Output ends of the first controllable switch and the second controllable switch are both coupled to the compensating line, and control ends of the first controllable switch and the second controllable switch are both coupled to the channel control unit. This is a specific circuit structure of the level switch module. Logical operation of the first controllable switch is opposite to logical operation of the second controllable switch, which avoids faulty action effectively.

Furthermore, the level conversion module further composes a third controllable switch. An input end of the third controllable switch is coupled to the compensating line, an output end of the third controllable switch is coupled to a discharge resistor, and a control end of the third controllable switch is coupled to the channel control unit. The third controllable switch is switched on after the first controllable switch is switched on and the third controllable switch is switched of after the second controllable switch is switched on, and the first controllable switch is switched off after the third controllable switch is switched on. The controllable switch discharges when the compensating line is in high level state to enable the voltage to be greatly reduced, and then the compensating line is reduced from a high level to a low level by the third controllable switch to form a chamfer waveform.

Furthermore, the driving circuit for an LCD panel comprises a timing control circuit (T-con) that outputs a compensating line clock signal and a chamfer control signal received by the channel control unit of the level conversion module. The first controllable switch is switched on at a positive edge of the compensating line clock signal, and is switched off at a negative edge of the chamfer control signal. The second controllable switch is switched on at a negative edge of the compensating line clock signal, and is switched of at the positive edge of the next compensating line clock signal. The third controllable switch is switched on at the negative edge of the chamfer control signal, and is switched off at the negative edge of the compensating line clock signal. The timing control circuit (T-con) controls output signals of the scan lines and the data lines of the LCD panel. Therefore, the compensating line clock signal and the chamfer control signal are provided by the timing control circuit (T-con), and the driving time and waveform of the compensating line are accurately controlled without additionally designing driving circuit, which reduces hardware cost and makes circuits simple.

An LCD device comprises the aforementioned driving circuit for a multi-subpixel charge sharing type LCD panel.

Furthermore, the LCD device comprises a panel and a control board. The panel comprises a plurality of scan lines and a compensating line. The control board comprises a timing control circuit (T-con), and a level conversion module coupled to the T-con. The level conversion module and the T-con are integrated into the same control hoard, so that distance between the level conversion module and the T-con is reduced, facilitating circuit design and reducing signal attenuation.

A driving method for a multi-subpixel charge sharing type LCD panel, comprising: step A: driving a compensating line of the LCD panel by a level conversion module after the level conversion module ends scanning of a last scan line and before the level conversion module begins scanning of a next frame.

Furthermore, the level conversion comprises a first controllable switch and a second controllable switch which are coupled to the compensating line, wherein the step A comprises:

A1: controlling the first controllable switch to be switched on at a positive edge of a compensating line clock signal, coupling a reference high-level signal to the compensating line;

A2: controlling the first controllable switch to be switched of at a negative edge of the compensating line clock signal, controlling the second controllable switch to be switched on, and coupling a reference low-level signal to the compensating line. This is one normal squarewave control waveform which makes circuits simple and reduces hardware cost.

Furthermore, the level conversion comprises a first controllable switch, a second controllable switch, and a third controllable switch which are coupled to the compensating line wherein the step A comprises:

A1: controlling the first controllable switch to be switched on at a positive edge of a compensating line clock signal, coupling a reference high-level signal to the compensating line;

A2: controlling the first controllable switch to be switched of at a negative edge of a chamfer control signal, switching on the third controllable switch, and coupling the compensating line to a discharge resistor to discharge;

A3: controlling the third controllable switch to be switched off at the negative edge of a compensating line clock signal, controlling the second controllable switch to be switched on, and coupling a reference low-level signal to the compensating line. This is another control waveform. A chamfer can be formed on the basis of the standard squarewave waveform to form a chamfer waveform, which increases control reliability.

Furthermore, the compensating line clock signal and the chamfer control signal are generated by the timing control circuit (T-com). The timing control circuit (T-con) controls the output signals of the scan lines and the data lines of the LCD panel. Therefore, the compensating line clock signal and the chamfer control signal are provided by the timing control circuit (T-con), and the driving time and waveform of the compensating line are accurately controlled without additionally designing driving circuit which makes circuits simple and reduces hardware cost.

In the present disclosure, because the level conversion module is independently used to drive the compensating tine and outputs a control signal to drive the compensating line after ending the scanning of the last scan line and before beginning the scanning of the next frame, the driver of the compensating line does not need to occupy the channels of the gate driver chips, and the number of gate driver chips is only configured in accordance with the number of the scan lines, thereby reducing channel waste and reducing hardware cost. In addition, it is not necessary to consider the match problem between the number of the output channels of the gate driver chips and the driver(s) of the scan lines and the compensating line. The driver of the scan lines is only designed as usual. The level conversion module only need to drive the compensating line and is relatively independent of other driving circuits, thereby being beneficial to reduce development difficulty and achieve simple design.

### BRIEF DESCRIPTION OF FIGURES

FIG. 1 is a schematic diagram of a typical multi-subpixel charge sharing type liquid crystal display (LCD) device;

FIG. 2 is a an interior circuit diagram of a multi-subpixel charge sharing type LCD panel;

FIG. 3 is a synthetic diagram of a multi-subpixel display;

FIG. 4 is a schematic diagram of an LCD device of an example of the present disclosure;

FIG. 5 is a connection diagram of a timing control circuit (T-con) and a level conversion module of an example of the present disclosure;

FIG. 6 is an interior circuit diagram of a level conversion module of an example of the present disclosure; and

FIG. 7 is a driving waveform diagram of an example of the present disclosure.

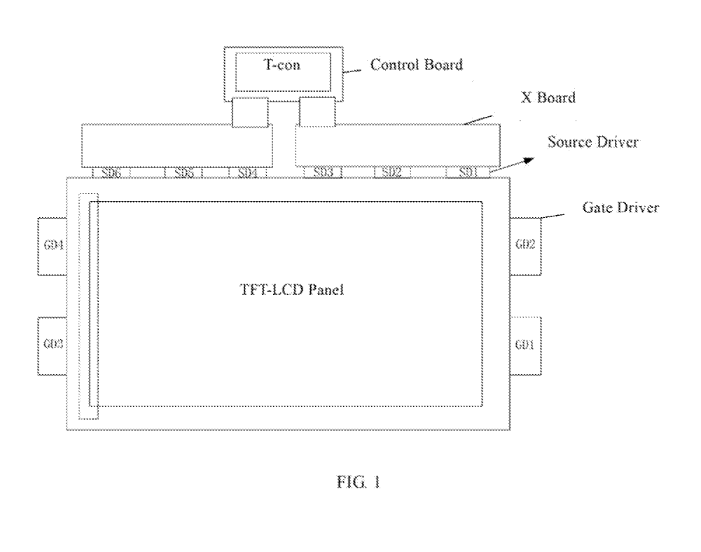

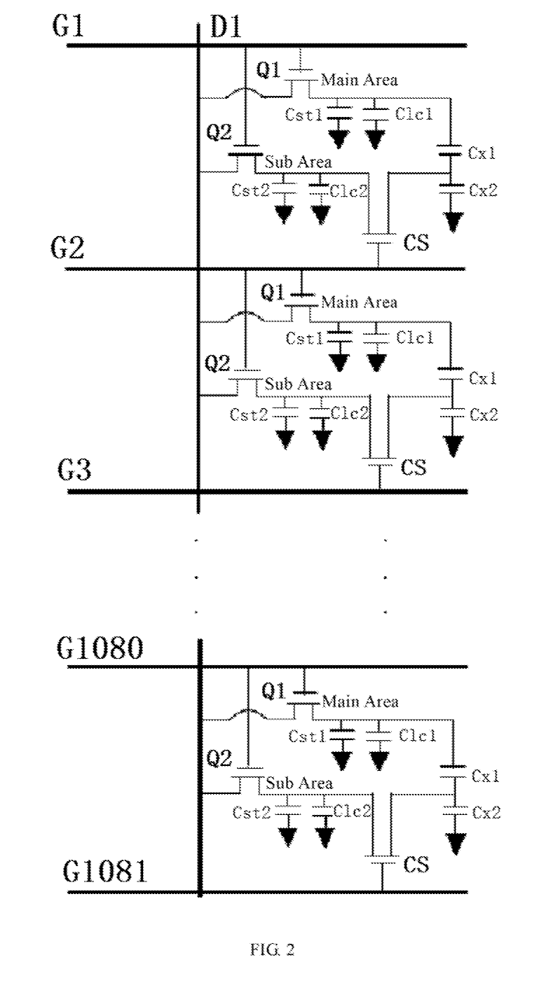

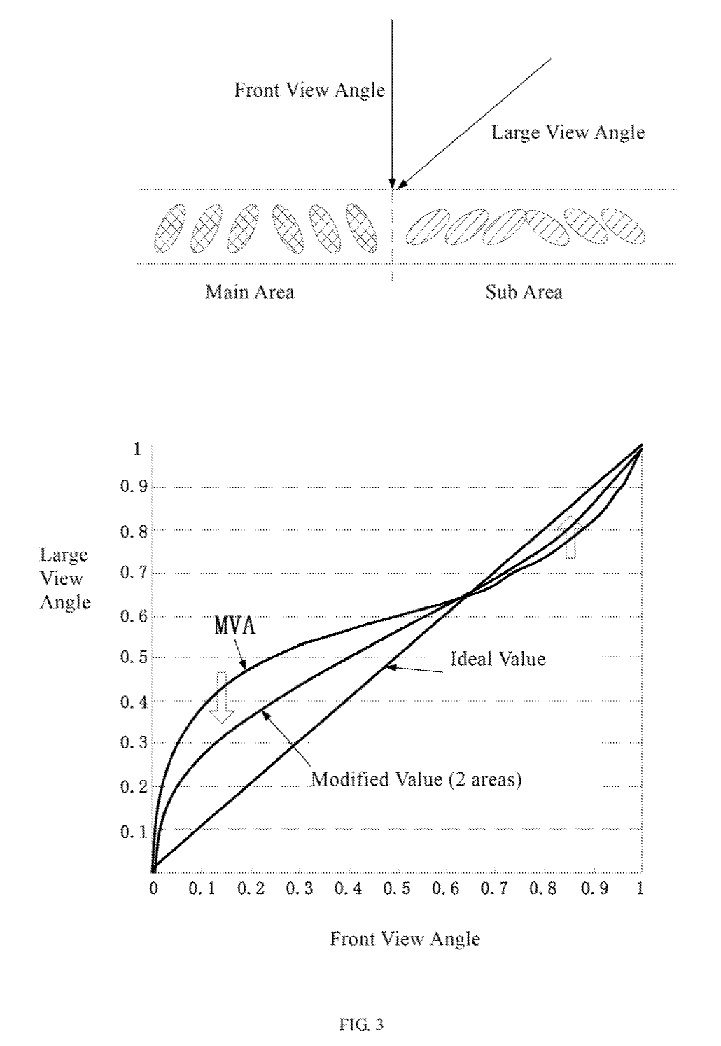

### DETAILED DESCRIPTION

The present disclosure provides a liquid crystal display (LCD) device. The LCD device comprises a multi-subpixel LCD panel and a driving circuit thereof. The LCD panel comprises a plurality of scan lines directly driven by gate driver chips, and further comprises a compensating line and a level conversion module coupled to the compensating line. The compensating line is not coupled to the scan lines. The level conversion module outputs a control signal to drive the compensating line after the level conversion module ends scanning of a last scan line and before the level conversion module begins scanning of a next frame.

In the present disclosure, because the level conversion module is independently used to drive the compensating line and outputs the control signal to drive the compensating line after the level conversion module ends the scanning of the last scan line and before the level conversion module begins the scanning of the next frame, a driver of the compensating line does not need to occupy channels of the gate driver chips, and the number of the gate driver chip is only configured in accordance with the number of the scan line, which reduces channel waste and hardware cost. In addition matching problem between the number of the channels output by the gate driver chips and the driver of the scan lines and the compensating lines do not need to be taken into consideration. The driver of the scan lines is only designed as usual and the level conversion module only needs to drive the compensating line and is relatively independent of another driving circuits, which reduces development difficulty and makes design simple.

The present disclosure will further be described in detail in accordance with the figures and the preferable examples.

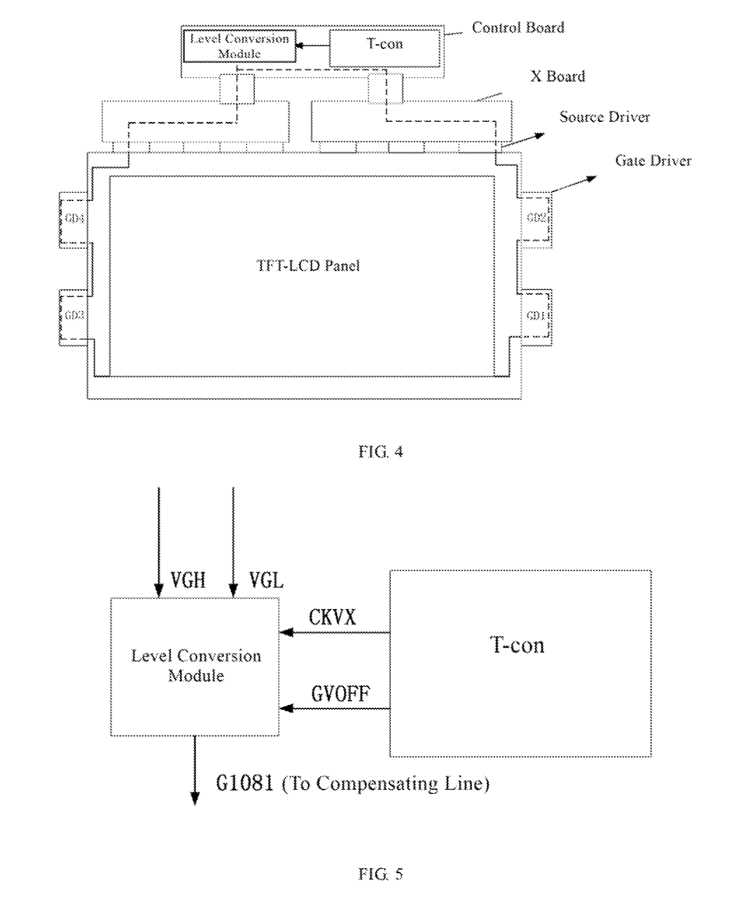

As shown in FIG. 4 and FIG. 5, the LCD panel is internally configured with scan lines and data lines crossing the scan lines, two sides of the LCD panel are both configured with two gate driver chips (GD1-GD4) which drive 1080 scan lines (G1-G1080) of the LCD panel, and a compensating line G1081 driven by the level conversion module. An upper part of the LCD panel is configured with a plurality of source driver chips, where the source driver chips are controlled by a source driver circuit board (X board), and the LCD panel is driven by a control board. The control board comprises a timing control circuit (T-con) and a level conversion module coupled to the timing control circuit (T-con).

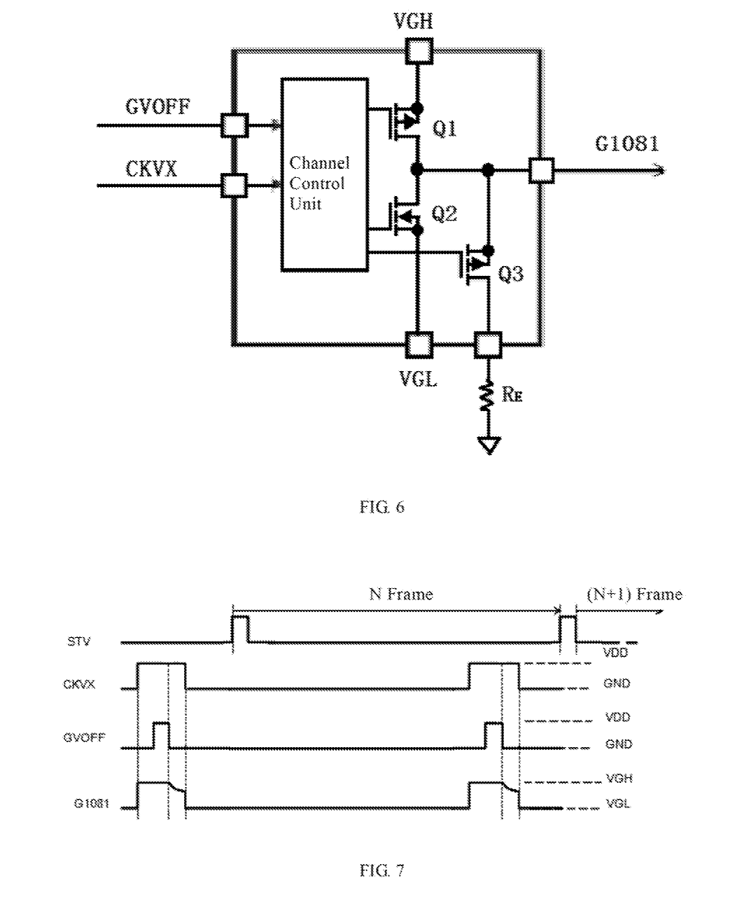

As shown in FIG. 6, the level conversion module comprises a first controllable switch Q1 is switched on at a high level, a second controllable switch Q2 is switched on at a low level, and a channel control unit that controls the first controllable switch Q1 and the second controllable switch Q2. An input end of the first controllable switch Q1 is coupled to a reference high-level signal VGH, and an input end of the second controllable switch Q2 is coupled to a reference signal VGL. Output ends of the first controllable switch Q1 and the second controllable switch Q2 are coupled to the compensating line G1081, and a control ends of the first controllable switch Q1 and the second controllable switch Q2 are coupled to the channel control unit. The level conversion module further comprises a third controllable switch Q3. An input end of the third controllable switch Q3 is coupled to the compensating line, an output end of the third controllable switch Q3 is coupled to a discharge resistor, and a control end of the third controllable switch Q3 is coupled to the channel control unit. The third controllable switch Q3 is switched on after the first controllable switch Q1 is switched on and the third controllable switch is switched off after the second controllable switch Q2 is switched on, and the first controllable switch Q1 is switched off after the third controllable switch Q3 is switched on. Logical operation of the first controllable switch Q1 is opposite to logical operation of the second controllable switch Q2, which avoids faulty action effectively. The third controllable switch Q3 discharges when the compensating line is in high level state to enable the voltage to be greatly reduced, and then the compensating line is reduced from a high level to a low level by the third controllable switch Q3 to form a chamfer waveform.

Furthermore, the channel control unit of the level conversion module receives a compensating line clock signal CKVX and a chamfer control signal GVOFF which are both output by the timing control circuit (T-con). The first controllable switch Q1 is switched on at a positive edge of the compensating line clock signal CKVX and is switched off at a negative edge of the chamfer control signal GVOFF. The second controllable switch Q2 is switched on at a negative edge of the compensating line clock signal CKVX, and is switched off at a positive edge of the next compensating line clock signal CKVX. The third controllable switch Q3 is switched on at the negative edge of the chamfer control signal GVOFF, and is switched off at the negative edge of the compensating line clock signal CKVX. The timing control circuit (T-con) controls output signals of the scan lines and the data lines of the LCD panel. Therefore, the compensating line clock signal CKVX and the chamfer control signal GVOFF are provided by the timing control circuit (T-con), and driving time and waveform of the compensating line are accurately controlled without additionally designing driving circuit, which reduces hardware cost and makes circuits simple.

The present disclosure further provides a driving method for a multi-subpixel LCD panel, comprising: a step A: driving a compensating line by a level conversion module after the level conversion module ends scanning of a last scan line and before the level conversion module begins scanning of next frame.

### EXAMPLE 1

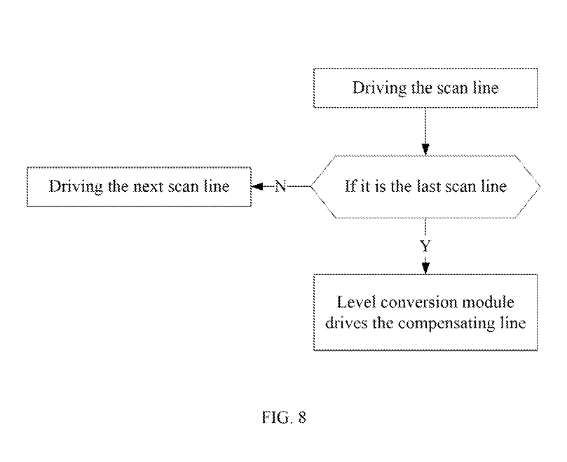

A level conversion comprises a first controllable switch, a second controllable switch, and a third controllable switch, and the step A comprises driving waveform as shown in FIG. 7:

A1: controlling the first controllable switch to be switched on at a positive edge of a compensating line dock signal CKVX, coupling a reference high-level signal to a compensating line G1081;

A2: controlling the first controllable switch to be switched of at a negative edge of a chamfer control signal GVOFF, and switching on the third controllable switch, coupling the compensating line to a discharge resistor to discharge;

A3: controlling the third controllable switch to be switched off at a negative edge of the compensating line clock signal CKVX, controlling the second controllable switch to be switched on, and coupling a reference low-level signal to the compensating line G1081.

The timing control circuit (T-con) controls the output signals of the scan lines and the data lines of the LCD panel. Therefore, the compensating line clock signal CKVX and the chamfer control signal GVOFF are provided by the timing control circuit (T-con), and the driving time and waveform of the compensating line are accurately controlled without additionally designing driving circuit, which reduces hardware cost and make circuits simple.

This is one specific control waveform. A chamfer can be formed on the basis of the standard squarewave waveform to form a chamfer waveform, thereby increasing the control reliability.

### EXAMPLE 2

A level conversion comprises a first controllable switch and a second controllable switch, and the step A comprises:

A1: controlling the first controllable switch to be switched on at a positive edge of a compensating line clock signal, coupling a reference high-level signal to a compensating line:

A2: controlling the first controllable switch to be switched off at a negative edge of the compensating line clock signal, controlling the second controllable switch to be switched on, and coupling a reference low-level signal to the compensating line.

This is one normal squarewave control waveform which is simply achieved, thereby simplifying design and corresponding hardware cost.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A driving circuit for a multi-subpixel charge sharing type liquid crystal display (LCD) panel, comprising:
a plurality of scan lines directly driven by gate driver chips,
a compensating line and a level conversion module coupled to the compensating line;
wherein the level conversion module outputs a control signal to drive the compensating line after the level conversion module ends scanning of a last scan line and before the level conversion module begins scanning of a next frame.

2. The driving circuit for the multi-subpixel charge sharing type LCD panel of claim 1, wherein the level conversion module comprises a first controllable switch that switches on at a high level, a second controllable switch is switched on at to low level, and a channel control unit that controls the first controllable switch and the second controllable switch;
wherein an input end of the first controllable switch is coupled to a reference high-level signal, and an input end of the second controllable switch is coupled to a reference low-level signal; output ends of the first controllable switch and the second controllable switch are coupled to the compensating line, and control ends of the first controllable switch and the second controllable switch are both coupled to the channel control unit.

3. The driving circuit for the multi-subpixel charge sharing type LCD panel of claim 2, wherein the level conversion module further comprises a third controllable switch; an input end of the third controllable switch is coupled to the compensating line, an output end of the third controllable switch is coupled to a discharge resistor, and a control end of the third controllable switch is coupled to the channel control unit;
wherein the third controllable switch is switched on after the first controllable switch is switched on and the third controllable switch is switched off after the second controllable switch is switched on and the first controllable switch is switched off after the thud controllable switch is switched on.

4. The driving circuit for the multi-subpixel charge sharing type LCD panel of claim 3, wherein the driving circuit further comprises a timing control circuit (T-con) that outputs a compensating line clock signal and a chamfer control signal received b the channel control unit of the level conversion module; the first controllable switch is switched on at a positive edge of the compensating line clock signal, and is switched off at a negative edge of the chamfer control signal; the second controllable switch is switched on at a negative edge of the compensating line clock signal, and is switched off at the positive edge of the next compensating line clock signal; the third controllable switch is switched on at the negative edge of the chamfer control signal, and is switched off at the negative edge of the compensating line clock signal.

5. A liquid crystal display (LCD) device, comprising:
a driving circuit for a multi-subpixel charge sharing type LCD panel, wherein the driving circuit comprises a plurality of scan lines directly driven by gate driver chips, and a compensating line and a level conversion module coupled to the compensating line; the level conversion module outputs a control signal to drive the compensating line after the level conversion module ends scanning of a last scan line and before the level conversion module begins scanning of a next frame.

6. The liquid crystal display (LCD) device of claim 5, wherein the level con version module comprises a first controllable switch is switched on at high level, a second controllable switch is switched on at low level, and a channel control unit that controls the first controllable switch and the second controllable switch;
an input end of the first controllable switch is coupled to a reference high-level signal, and an input end of the second controllable switch is coupled to a reference low-level signal; an output ends of the first controllable switch and the second controllable switch are coupled to the compensating line, and a control ends of the first controllable switch and the second controllable switch are both coupled to the channel control unit.

7. The liquid crystal display (LCD) device of claim 5, wherein the level conversion module further comprises a third controllable switch; an input end of the third controllable switch is coupled to the compensating line, an output end of the third controllable switch is coupled to a discharge resistor, and the control end of the third controllable switch is coupled to the channel control unit;
wherein the third controllable switch is switched on after the first controllable switch is switched on and the third controllable switch is switched off after the second controllable switch is switched on, and the first controllable switch is switched off after the third controllable switch is switched on.

8. The liquid crystal display (LCD) device of claim 7, wherein the driving circuit further comprises a timing control circuit (T-con) that outputs a compensating line clock signal and a chamfer control signal received by the channel control unit of the level conversion module; the first controllable switch is switched on at a positive edge of the compensating line clock signal, and is switched off at a negative edge of the chamfer control signal; the second controllable switch is switched on at a negative edge of the compensating line clock signal, and is switched off at the positive edge of the next compensating line clock signal; the third controllable switch is switched on at the negative edge of the chamfer control signal, and is switched off at the negative edge of the compensating line clock signal.

9. The liquid crystal display (LCD) device of claim 5, wherein the LCD device comprises a panel and a control board; the panel comprises a plurality of scan lines and a compensating line, and the control board comprises a timing control circuit (T-con) and a level conversion module coupled to the T-con.

10. A driving method for a multi-subpixel liquid crystal display (LCD) panel, comprising:
step A: driving a compensating line of the LCD panel by a level conversion module after the level conversion module ends scanning of a last scan line and before the level conversion module begins scanning of a next frame.

11. The driving method for the multi-subpixel liquid crystal display (LCD) panel of claim 10, wherein the level conversion comprises a first controllable switch and a second controllable switch which are coupled to the compensating line, wherein the step A comprises:
A1: controlling the first controllable switch to be switched on at a positive edge of a compensating line clock signal; coupling a reference high-level signal to the compensating line;
A2: controlling the first controllable switch to be switched off at a negative edge of the compensating line dock signal, controlling the second controllable switch to be switched on, and coupling a reference low-level signal to the compensating line.

12. The driving method for a multi-subpixel liquid crystal display (LCD) panel of claim 10, wherein the level conversion comprises a first controllable switch, a second controllable switch, and a third controllable switch which are coupled to the compensating line wherein the step A, comprises:
A1: controlling the first controllable switch to be switched on at a positive edge of a compensating line clock signal; coupling a reference high-level signal to the compensating line;
A2: controlling the first controllable switch to be switched off at a negative edge of a chamfer control signal, switching on the third controllable switch, and coupling the compensating line to a discharge resistor to discharge;
A3: controlling the third controllable switch to be switched off at the negative edge of a compensating line clock signal, controlling the second controllable switch to be switched on, and coupling a reference low-level signal to the compensating line.

13. The driving method for a multi-subpixel LCD panel of claim 12, wherein the compensating line clock signal and the chamfer control signal are output by a timing control circuit (T-con) of the LCD panel.
